(19) United States
(12) Patent Application Publication
(10) Pub. No.: US 2026/0296698 A1
(43) Pub. Date: Oct. 1, 2026

(54) WRAPPING MACHINE

(71) Applicant: FLEXISPOT INC., Irvine, CA (US)

(72) Inventors: Yufeng YUAN, Irvine, CA (US); Shuai WANG, Irvine, CA (US); Hongliang XU, Irvine, CA (US); Haibo XU, Irvine, CA (US); Guangqiang ZHANG, Irvine, CA (US)

(21) Appl. No.: 19/323,748

(22) Filed: Sep. 9, 2025

(30) Foreign Application Priority Data
Mar. 28, 2025 (CN) 202510384944.1
Mar. 28, 2025 (CN) 202520571976.8

(51) Int. Cl. B65B 11/02

(52) U.S. Cl. CPC B65B 11/02; B25J 9/1687; B25J 18/00; B25J 19/0016; B65B 45/00; B25J 9/009; B65B 2210/14

(57) ABSTRACT

A wrapping machine includes a cantilever lifting mechanism, which includes a column, a cantilever, a pushing rod assembly and an assisting structure. The cantilever includes a first end and a second end. The column is rotatably connected to the cantilever at a first connection position, the first connection position is closer to the second end of the cantilever. The pushing rod assembly is connected to the cantilever at a second connection position, the pushing rod assembly can drive the cantilever to rotate relative to the column. The assisting structure is connected to the cantilever at a third connection position, and the assisting structure can provide assisting force for the first end of the cantilever to rise. The assisting structure provides rotation assisting for the cantilever, thereby improving the transmission efficiency, increasing the thrust, and further accelerating the activity reaction speed of the cantilever.

### CROSS-REFERENCE TO RELATED APPLICATIONS

This present application claims the priorities of Chinese Patent Application No. 202510384944.1 filed to China National Intellectual Property Administration on Mar. 28, 2025, Chinese Patent Application No. 202520571976.8 filed to China National Intellectual Property Administration on Mar. 28, 2025, which are hereby incorporated by reference in their entireties.

### TECHNICAL FIELD

The present application relates to the field of film wrapping equipment, and in particular to a wrapping machine.

### BACKGROUND

Cantilever wrapping vehicles (also known as wrapping machines) are widely used in logistics, packaging and other industries due to their flexible use, simple operation and convenient maintenance. Cantilever wrapping vehicles are usually equipped with a walking mechanism, such as a walking wheel with a driving motor, which is used to drive the wrapping vehicle to move around the goods to package the goods. The cantilever wrapping vehicles also include a column, where a cantilever is pivotally mounted on the column, a pushing rod assembly is connected to the cantilever, and a film roll storage box is installed at the other end of the cantilever away from the column to accommodate the film rolls used for packaging. When the pushing rod assembly retracts or moves away from the cantilever, it drives the cantilever down, causing the film roll storage box to lower; conversely, when the pushing rod assembly extends or moves toward the cantilever, it pushes the cantilever up, causing the film roll storage box to rise. In this way, the cantilever wrapping vehicle can adapt to goods of different heights and has a wide range of application scenarios.

However, since the pushing rod assembly is used frequently during the actual use of the cantilever wrapping vehicle, there are problems of high power consumption and short endurance time.

### SUMMARY OF THE INVENTION

The present application provides a wrapping machine, including a cantilever lifting mechanism, where the cantilever lifting mechanism includes:
a cantilever, which includes a first end and a second end;
a column, which is rotatably connected to the cantilever at a first connection position, the first connection position being closer to the second end of the cantilever;
a pushing rod assembly, which is connected to the cantilever at a second connection position, the pushing rod assembly being configured to drive the cantilever to rotate relative to the column;
an assisting structure, which is connected to the cantilever at a third connection position, and the assisting structure being configured to provide assisting force for the first end of the cantilever to rise.

In some embodiments, the second connection position and the third connection position are respectively located on two sides of the first connection position.

In some embodiments, the third connection position is located at the second end of the cantilever.

In some embodiments, one end of the assisting structure is connected to the cantilever at the third connection position, the other end is connected to a first fixing base, and the first fixing base is arranged in or near a bottom area of the column.

In some embodiments, the assisting structure is a tension spring or a spring balancer.

In some embodiments, the column includes a first side and a second side, the first side of the column is closer to the second connection position and the second side of the column is further away from the second connection position, the first connection position is located on the first side of the column, and a distance between the third connection position and the second side of the column is smaller than a distance between the third connection position and the first side of the column.

In some embodiments, the second connection position and the third connection position are located on a same side of the first connection position.

In some embodiments, an upper end of the assisting structure is connected to the third connection position, and the assisting structure is a compression spring or a gas spring.

In some embodiments, the assisting structure is a spring balancer, the third connection position is located on an upper surface of the cantilever, and a movable end of the spring balancer is connected to the third connection position by passing through the second end of the cantilever.

In some embodiments, the cantilever includes a cantilever body and an assisting plate, a first end of the assisting plate is connected to one end of the cantilever body, and a second end of the assisting plate extends along an axial direction of the cantilever body in a direction away from the cantilever body to form the second end of the cantilever.

In some embodiments, the cantilever lifting mechanism further includes a limiting element and a first rotating shaft, one end of the limiting element is connected to a first end of the cantilever body, and the other end of the limiting element is rotatably connected to the column through the first rotating shaft, and the column and the cantilever are rotatably connected at the first connection position through the first rotating shaft.

In some embodiments, the limiting element includes two limiting plates arranged opposite to each other, an accommodation space is defined between the two limiting plates, the first end of the cantilever body extends into the accommodation space, and the two limiting plates are respectively arranged on both sides of the cantilever body.

In some embodiments, the cantilever lifting mechanism further includes a first bearing base and a first bearing, the first bearing base is mounted on the column, at least a part of the first bearing base extends into and is limited in the accommodation space, the first bearing is mounted on the first bearing base, and the first rotating shaft passes through the first bearing.

In some embodiments, the pushing rod assembly includes a second bearing base, a ball screw, a screw nut and a driving assembly, the second bearing base is pivotally connected to the column or the first fixing base, one end of the ball screw is pivotally connected to the cantilever, the screw nut is configured to rotate in the second bearing base, the ball screw is threadedly connected to the screw nut, and the driving assembly is configured to drive the screw nut to rotate.

In some embodiments, the driving assembly includes a motor, a first sprocket, a second sprocket and a chain, the motor is mounted on the second bearing base, the motor is connected to the first sprocket in a transmission manner, the second sprocket is connected on the screw nut, and the first sprocket is connected to the second sprocket via the chain in a transmission manner; the pushing rod assembly further includes a nut base and a second bearing, the nut base is disposed between the second bearing base and the screw nut, the second bearing base and the nut base are in a rotation cooperation via the second bearing, and the screw nut is mounted in the nut base.

In some embodiments, a first limiting detection block and a second limiting detection block are respectively disposed at two ends of the ball screw, and a first limiting switch and a second limiting switch are disposed on the second bearing base, and when the first limiting switch detects the first limiting detection block or when the second limiting switch detects the second limiting detection block, the driving assembly stops driving the screw nut to rotate.

Other features and advantages of the present application will become apparent from the following detailed description of exemplary embodiments of the present application with reference to the accompanying drawings.

### BRIEF DESCRIPTION OF THE DRAWINGS

FIG. 1 is a schematic structural diagram of an embodiment of a wrapping machine of the present application.

FIG. 2 is a schematic structural diagram of an embodiment of the wrapping machine of the present application in which a first fixing base is arranged in a bottom area of the column.

FIG. 3 is a schematic structural diagram of an embodiment of a connection position between a cantilever body and a column in the wrapping machine of the present application.

FIG. 4 is a schematic structural diagram of an embodiment of the connection position between the cantilever body and the column in the wrapping machine of the present application.

FIG. 5 is a schematic structural diagram of an embodiment of a pushing rod assembly in the wrapping machine of the present application.

FIG. 6 is a structural cross-sectional view of an embodiment of the pushing rod assembly in the wrapping machine of the present application.

FIG. 7 is a schematic structural diagram of an embodiment of the connection position between a ball screw and a first connecting base in the wrapping machine of the present application.

FIG. 8 is a schematic structural diagram of an embodiment of an installation structure of an assisting structure in the wrapping machine of the present application.

FIG. 9 is a schematic structural diagram of an embodiment of the connection position between the assisting structure and an assisting plate in the wrapping machine of the present application.

FIG. 10 is a schematic structural diagram of an embodiment of the connection between the assisting structure and the first fixing base in the wrapping machine of the present application.

FIG. 11 is a schematic structural diagram of an embodiment of the ball screw extending into a first fixing base in the wrapping machine of the present application.

FIG. 12 is a schematic structural diagram of an embodiment of the wrapping machine of the present application.

FIG. 13 is a schematic structural diagram of an embodiment of the installation structure of the assisting structure in the wrapping machine of the present application.

FIG. 14 is a schematic structural diagram of an embodiment of the installation structure of the assisting structure in the wrapping machine of the present application.

FIG. 15 is a schematic structural diagram of an embodiment of the installation structure of the assisting structure in the wrapping machine of the present application.

FIG. 16 is a schematic structural diagram of an embodiment of the installation structure of the assisting structure in the wrapping machine of the present application.

### DETAILED DESCRIPTION

The embodiments of the present application are further described below in conjunction with the drawings and specific examples, but are not intended to be limiting of the embodiments of the present application.

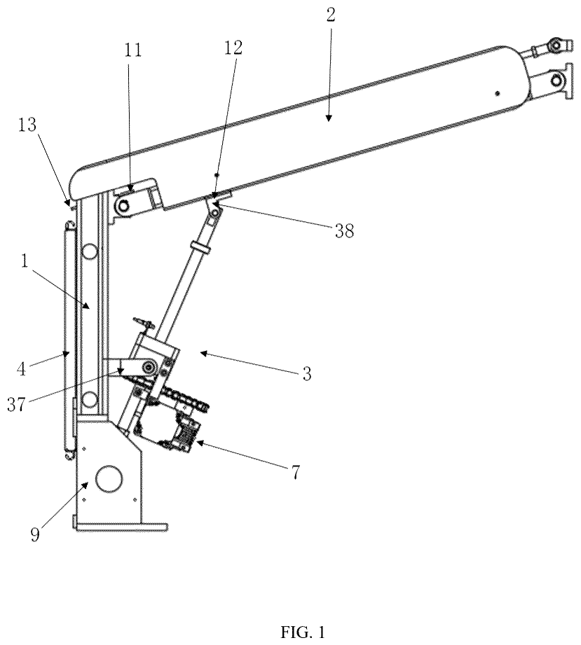

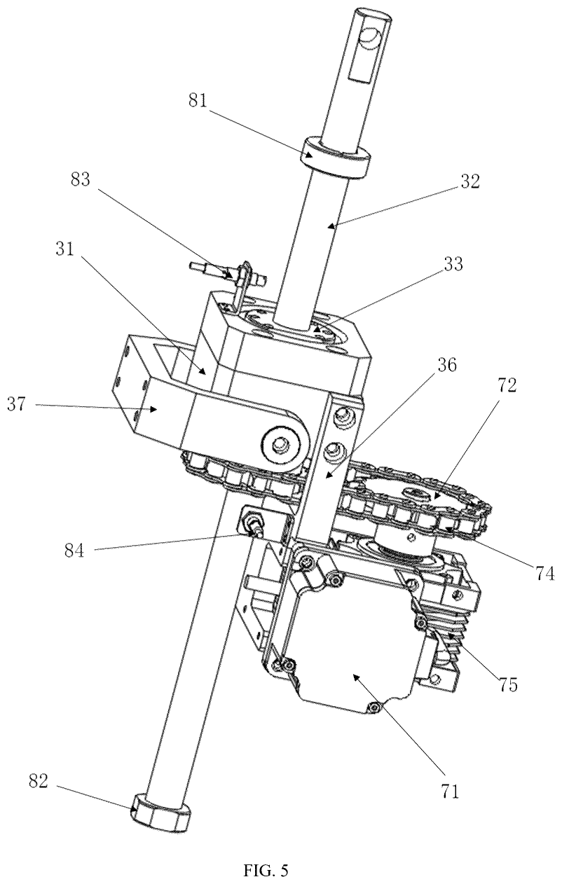

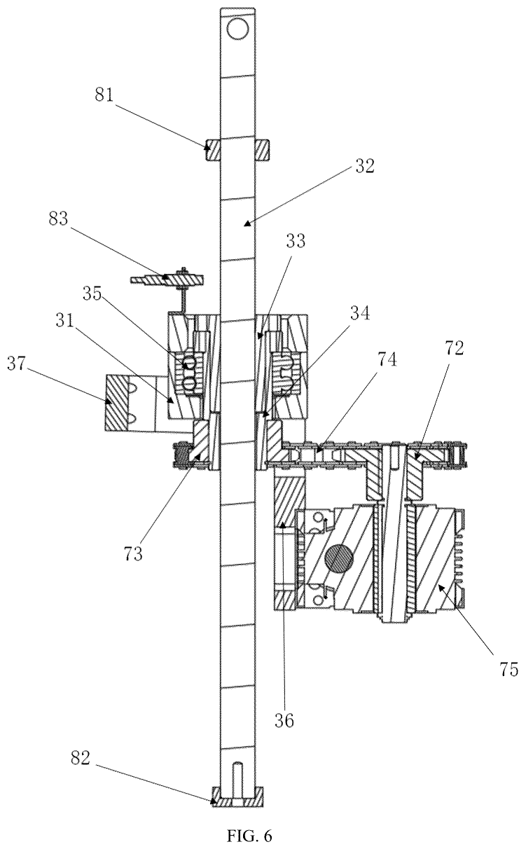

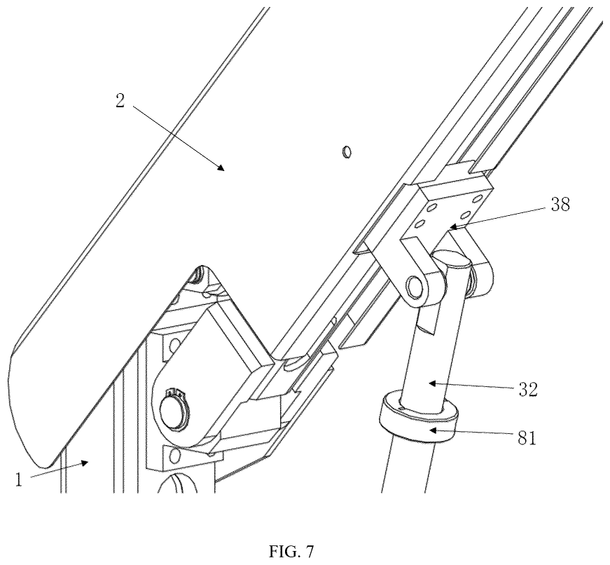

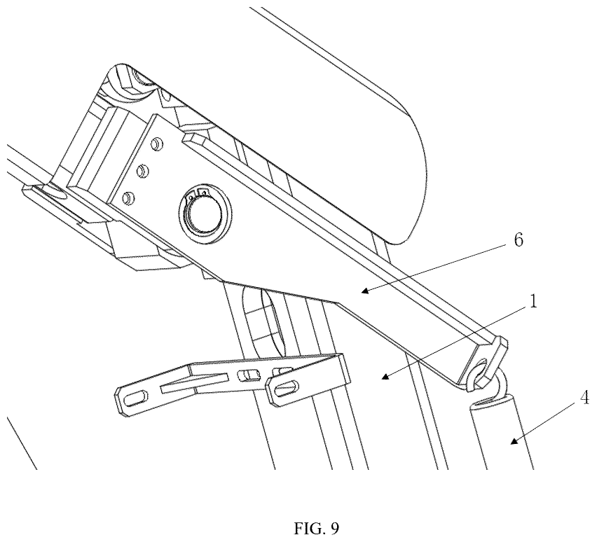

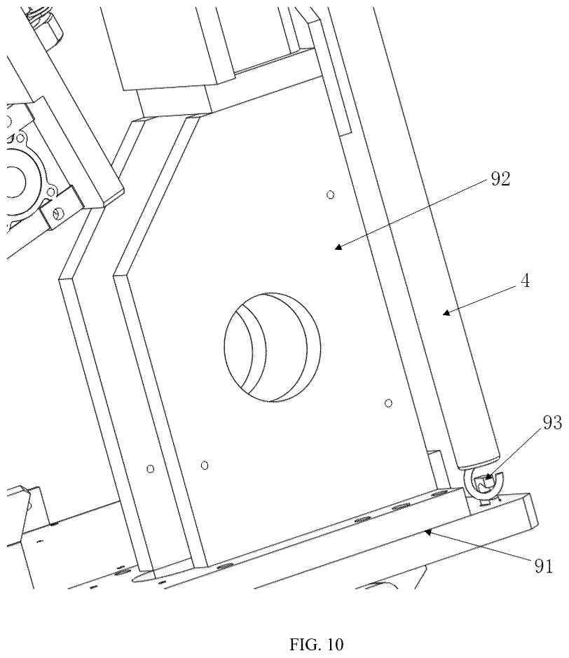

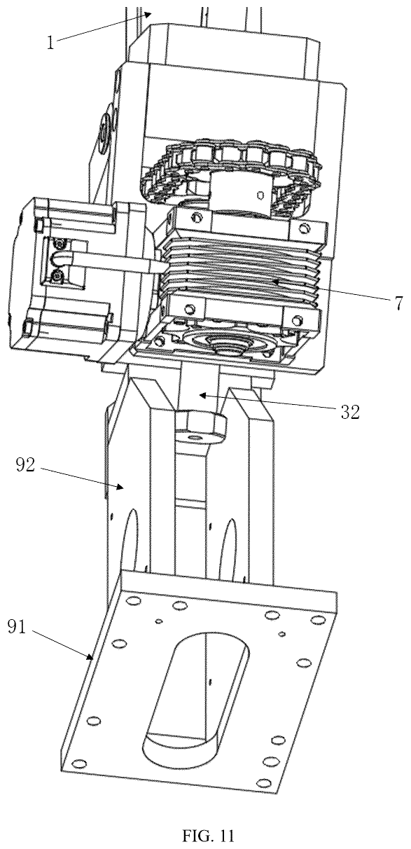

As shown in FIGS. 1 to 12, in one embodiment, the wrapping machine includes a cantilever lifting mechanism, which includes: a column 1, a cantilever 2, a pushing rod assembly 3, and an assisting structure 4. The cantilever 2 includes a first end and a second end. The column 1 and the cantilever 2 are rotatably connected at a first connection position 11, and the first connection position 11 is closer to the second end of the cantilever 2. The pushing rod assembly 3 and the cantilever 2 are connected at a second connection position 12, and the pushing rod assembly 3 is configured to drive t he cantilever 2 to rotate relative to the column 1. The assisting structure 4 and the cantilever 2 are connected at a third connection position 13, and the assisting structure 4 can provide power for the first end of the cantilever 2 to rise.

The pushing rod assembly 3 is rotatably connected to the cantilever 2 at the second connection position 12. The pushing rod assembly 3 may be an electric pushing rod. In some embodiments, the pushing rod assembly 3 may be one of a gas spring telescopic pushing rod, a hydraulic telescopic pushing rod, a direct drive sprocket chain pushing rod, or a ball screw pushing rod. When the pushing rod assembly 3 is working, its telescopic movement drives the cantilever 2 to rotate around the first connection position 11, thereby driving a film roll storage box 10 connected to the first end of the cantilever 2 to rise and fall.

In some embodiments, the second connection position 12 and the third connection position 13 are respectively located on two sides of the first connection position 11. The second connection position 12 is located on a side, which is closer to the first end of the cantilever 2, of the first connection position 11. That is, the second connection position 12 is located on a side of the cantilever 2 extending to lift the film roll storage box 10. The second connection position 12 can be located on a part, which is close to the first connection position 11 of the cantilever 2. The third connection position 13 is located on a side, which is closer to the second end of the cantilever 2, of the first connection position 11.

In some embodiments, as shown in FIGS. 1-3, a first connecting base 38 is disposed at a bottom of the cantilever 2, and one end of the pushing rod assembly 3 is pivotally connected to the first connecting base 38. The first connecting base 38 can be connected to the cantilever 2 by at least one of bolt(s), pin(s), rivet(s), welding and other connection methods, providing a stable pivot connecting base for the pushing rod assembly 3. The first connecting base 38 may be a double-ear type pivot base, with one ear plate on each side to form a symmetrical structure, and pivot holes are disposed on both ear plates. A radial through hole is disposed at one end of the pushing rod assembly 3, and the radial through hole is aligned with the pivot holes on the ear plates of the first connecting base 38. A rotating shaft is inserted therein, so that the pushing rod assembly 3 can rotate relative to the first connecting base 38. With the double-ear type pivot base, shaking of the pushing rod assembly 3 can be reduced, thereby improving the stability and seismic resistance of the entire cantilever lifting mechanism.

The outer end surfaces of the radial through hole at the end of the pushing rod assembly 3 are planes. In some embodiments, the end of a screw rod of the pushing rod assembly 3 may be rotatably connected to the first connecting base 38. The screw rod may be cylindrical as a whole, and a cantilever connection portion is disposed at an end of the screw rod. One side of the cantilever connection portion and the other side radially opposite thereto are planes, and the outer end surfaces of two openings of the radial through hole are respectively located on the two plane sides of the cantilever connection portion. That is, the two outer end surfaces of the radial through hole at the end of the pushing rod assembly 3 are planes, which are convenient for tightly fitting with the ear plates on both sides of the first connecting base 38 to form a stable rotational connection. In some embodiments, the cantilever connection portion at the end of the pushing rod assembly 3 may be a connecting plate welded or screwed to the end, and the two sides of the connecting plate are planes. The radial through hole at the end of the pushing rod assembly 3 is disposed on the connecting plate to tightly fit with the ear plates on both sides of the first connecting base 38.

In order to enhance the stability of the connection between the pushing rod assembly 3 and the cantilever 2, washer(s) may be disposed between the outer end surfaces of the radial through hole at the end of the pushing rod assembly 3 and the pivot holes on the first connecting base 38.

The assisting structure 4 is any structure that can assist in the upward movement of the first end of the cantilever 2 by providing mechanical energy or elastic potential energy when the first end of the cantilever 2 rises.

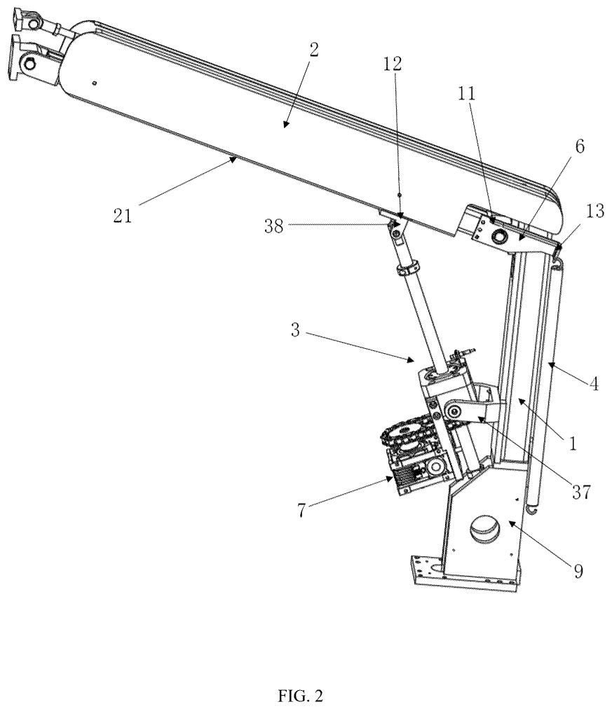

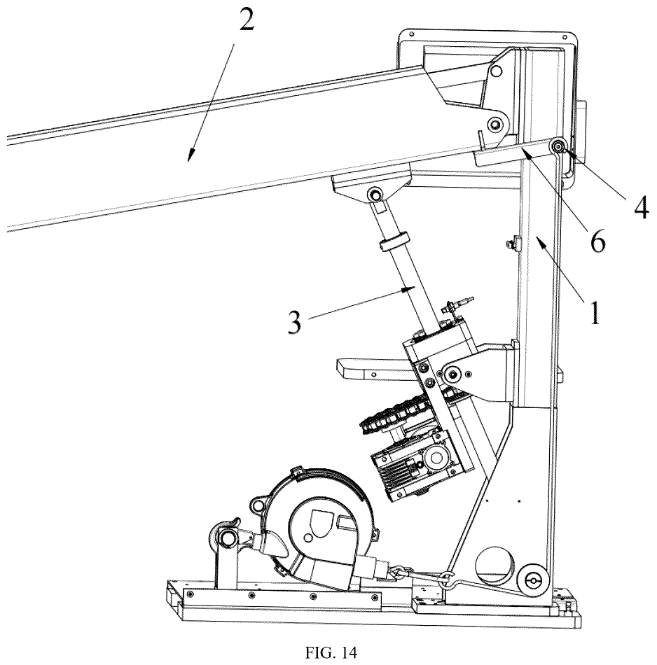

In some embodiments, as shown in FIG. 2 and FIG. 14, the assisting structure 4 may be an element with damping properties. When the first end of the cantilever 2 is in a lower position, the assisting structure 4 stores elastic potential energy and provides assisting force for the cantilever 2 to raise the first end by providing the stored elastic potential energy. Specifically, the assisting structure 4 may be a tension spring. When the first end of the cantilever 2 is in a lower position, the tension spring is stretched and accumulates elastic potential energy for providing assisting force for the cantilever 2 to raise the first end thereof, thereby reducing the burden on the pushing rod assembly 3 and reducing its energy consumption. The assisting structure 4 may be a spring balancer, which provides assisting force for the cantilever 2 to raise the first end thereof through the elastic force of the spring balancer.

With the assisting structure 4 providing the cantilever 2 with rotational assist, the load of the pushing rod assembly 3 can be reduced, thereby reducing the required output power, reducing the power consumption of the motor, and increasing the endurance time of the wrapping machine.

In some embodiments, the third connection position 13 may be disposed at the second end of the cantilever 2. Specifically, the assisting force of the assisting structure 4 can directly act on the farthest end of the cantilever 2, thereby generating the maximum torque when the cantilever 2 rotates, and obtaining a better assisting effect. The end of the cantilever 2 may be directly connected to the assisting structure 4. The cantilever 2 may be connected to the assisting structure 4 through a connection base or an ear connection plate. The connection base or the ear connection plate can be of a variety of shapes, such as round, square or other irregular shapes, with holes on them. A hook may be disposed on the top of the assisting structure 4 to be hooked onto the hole.

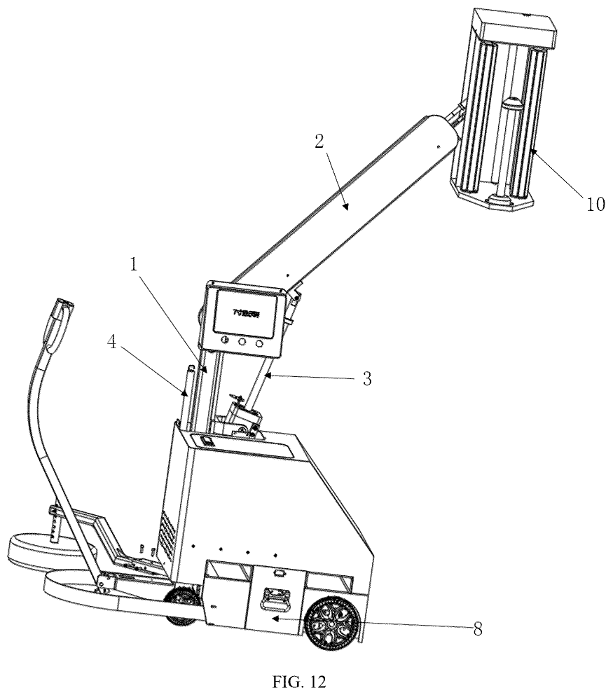

As shown in FIG. 12, the film roll storage box 10 is installed at the first end of the cantilever 2. The wrapping machine in the present application adopts the cantilever lifting mechanism as described above, which can reduce energy consumption and increase the endurance time of the wrapping machine.

In some embodiments, one end of the assisting structure 4 is connected to the cantilever 2 at the third connection position 13, and the other end is connected to the first fixing base 9, and the first fixing base 9 is disposed in a bottom area of the column 1.

In some embodiments, the first fixing base 9 may be arranged in the bottom area of the column 1. That is, the first fixing base 9 is a fixing base arranged at the bottom of the column 1. The first fixing base 9 may be a ring buckle extending laterally outward from the bottom side of the column 1, or it may be a fixing plate connected to the column 1 by welding, bolt connection, etc. A connecting structure cooperating with the assisting structure 4 is arranged on the fixing plate. For example, a hook is arranged at the end of the assisting structure 4, and a ring buckle is arranged on the fixing plate.

In some embodiments, one end of the assist structure 4 is connected to the cantilever 2 at the third connection position 13. The other end is connected to the first fixing base 9, which may be arranged near the bottom area of the column 1. Specifically, the first fixing base 9 may be an independent fixing base near the bottom of the column 1.

In some embodiments, one end of the assisting structure 4 may be connected to the cantilever 2 at the third connection position 13, and the other end may be fixed to other parts of the wrapping machine. Specifically, the other end should be lower than the third connection 13 so that the assisting structure 4 releases potential energy during the rising process of the first end of the cantilever 2.

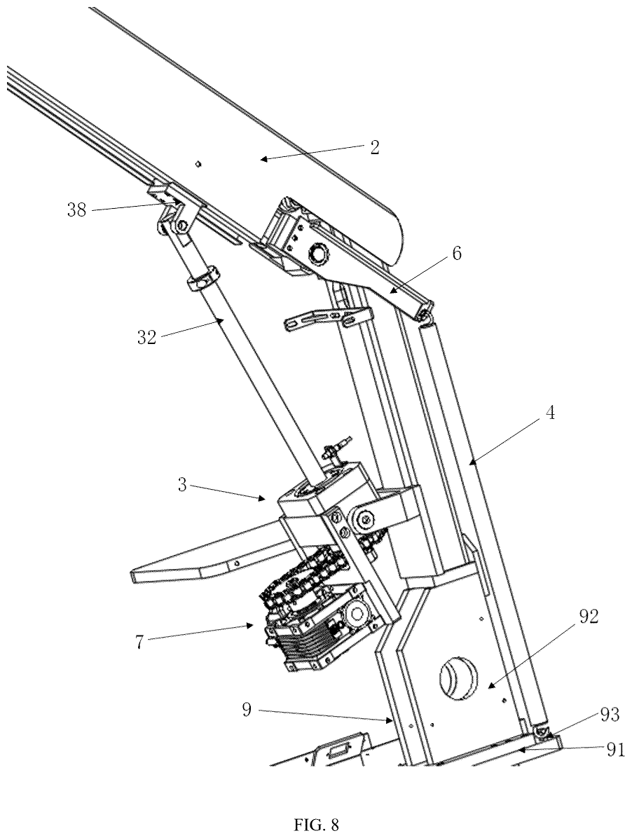

In some embodiments, as shown in FIGS. 8, 10, and 11, the first fixing base 9 includes a bottom plate 91 and a double-ear plate 92 extending upward in a direction perpendicular to the bottom plate 91. One end of the assisting structure 4 is connected to the bottom plate 91. A buckle 93 may be disposed on the bottom plate 91 and connected to a hook at the end of the assisting structure 4. The bottom plate 91 is in a shape of a flat plate. The bottom plate 91 is mounted on a base of the wrapping machine. The bottom plate 91 can be connected to the base of the wrapping machine in a screw manner. In some embodiments, a part of the base of the wrapping machine can also be used as the bottom plate 91. In some embodiments, a plate welded to the base of the wrapping machine may serve as the bottom plate 91. The double-ear plates 92 include two symmetrically arranged ear-plates perpendicular to the bottom plate 91. One end of the ear-plate is connected to the bottom plate 91 by welding or other firm connection methods, and the other end is away from the bottom plate 91 and extends upward in a direction perpendicular to the bottom plate 91 to form a door-like frame. The bottom of the column 1 is mounted to the top of the double-ear plate 92 of the first fixing base 9. An accommodation space is formed between the two ear-plates of the double-ear plate 92 for the screw rod of the pushing rod assembly 3 to pass through.

In some embodiments, the column 1 includes a first side and a second side. The first side of the column 1 is closer to the second connection position 12 and the second side of the column 1 is further away from the second connection position 12. The first connection position 11 is located on the first side of the column, and a distance between the third connection position 13 and the second side of the column 1 is smaller than a distance between the third connection position 13 and the first side of the column 1. In some embodiments, the first connection position 11 may be located near the first side of the column 1.

As shown in FIG. 2, the column 1 is closer to the first side of the second connection 12. That is, the first side of the column 1 refers to the side of the column 1 toward the direction of the cantilever extension, or refers to the side where the main part of the cantilever 2 is located. The column 1 is further away from the second side of the second connection position 12, which can be referred to as the other side radially opposite to the first side. The connection position between the assisting structure 4 and the cantilever 2, which can be referred to as the third connection position 13, is closer to the second side of the column 1. With these arrangements, the assisting structure 4 can provide greater assisting force.

In some embodiments, the second connection position and the third connection position may be located on a same side of the first connection position.

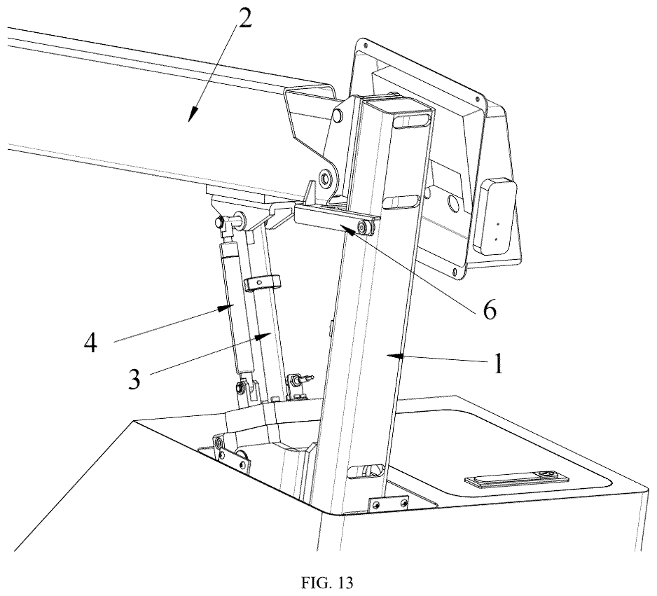

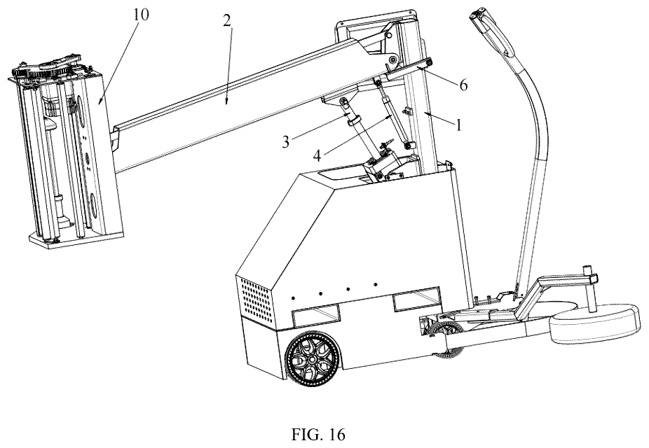

As shown in FIGS. 13 and 16, the upper end of the assisting structure may be connected to the third connection position, and the lower end may be connected to any suitable portion of the wrapping machine. The assisting structure may be a compression spring, a gas spring or an electric pushing rod. Specifically, the upper end of the assisting structure can be connected to the bottom surface, the side surface or the upper surface of the cantilever, and the lower end of the assisting structure may be connected to the lower part of the column or the lower part of the pushing rod assembly 3. The third connection position may be located on the side of the second connection position close to the first connection position, or on the side of the second connection position away from the first connection position, or it can coincide with the second connection position. When the first end of the cantilever 2 is in a lower position, the compression spring or gas spring can be compressed, storing elastic potential energy, and providing assistance to the cantilever 2 to make the first end rise, thereby reducing the burden on the pushing rod assembly 3 and reducing its energy consumption.

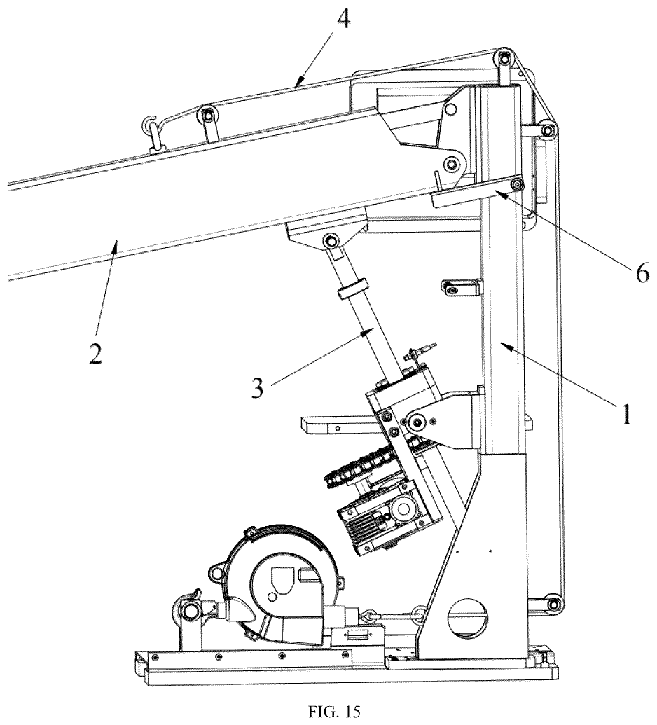

In some embodiments, as shown in FIG. 15, the assisting structure is a spring balancer, and the movable end of the spring balancer may be connected to the third connection position on the cantilever 2 by passing through the second end of the cantilever, or the movable end of the spring balancer may be connected to the third connection position on the cantilever 2 by passing through the top of the column. The third connection position may be located on the upper surface, side surface or bottom surface of the cantilever. When the first end of the cantilever 2 rises, the elastic force of the balancer provides the cantilever 2 with an assisting force to make the first end rise.

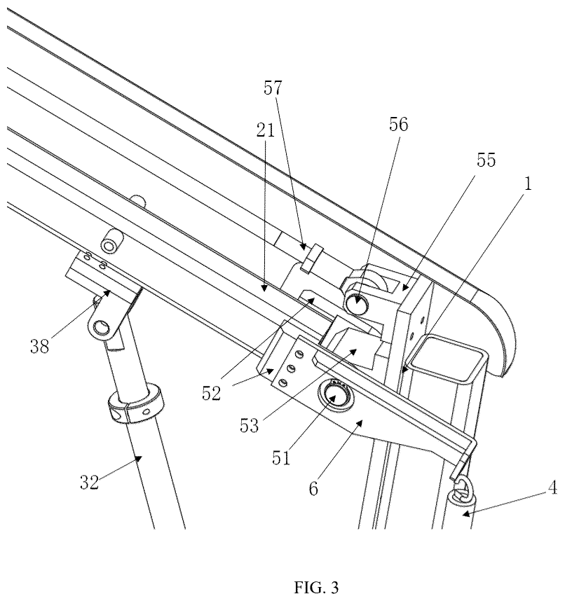

In some embodiments, as shown in FIG. 3, the cantilever 2 includes a cantilever body 21 and an assisting plate 6. A first end of the assisting plate 6 may be directly or indirectly connected to one end of the cantilever body 21, and a second end of the assisting plate 6 extends along the axial direction of the cantilever body 21 in a direction away from the cantilever body 21 to form the second end of the cantilever.

The column is rotatably connected to the cantilever at the first connection position. Specifically, as shown in FIG. 3, the first connection position may be located at the overlapping portion of the cantilever body 21 and the assisting plate 6; and as shown in FIG. 16, the first connection position may be located at the non-overlapping portion of the cantilever body 21. In addition, the first connection position may be located at the non-overlapping portion of the assisting plate 6. When the first connection position is located at the overlapping portion of the cantilever body 21 and the assisting plate 6, the column may be directly rotatably connected to the cantilever body 21 and the assisting plate 6, or the column may be directly rotatably connected to the cantilever body 21 but not directly rotatably connected to the assisting plate 6. For example, the column may be rotatably connected to the cantilever body 21 via a rotation shaft, but the rotation shaft is not inserted into the assisting plate.

In some embodiments, the assisting plate 6 and the cantilever body 21 may form an integrated structure with higher overall rigidity and strength, which can withstand greater loads and impact forces, have better stability, reduce maintenance, and are less likely to loosen or deform. There is no need for disassembly and assembly between the two, making the installation process simpler and faster, and reducing the overall weight.

In some embodiments, the assisting plate 6 may be connected to the cantilever body 21 by fasteners. The fasteners are structures such as screws or bolts, which are more flexible. The cantilever body 21 or the assisting plate 6 can be replaced separately without replacing the entire cantilever structure, thereby reducing maintenance costs, as well as lowering processing difficulty and processing costs.

The second end of the assisting plate 6 may extend beyond the side of the column 1 away from the first end of the cantilever 2 to obtain a more reasonable lever arm length, thereby providing effective assisting power and reducing the burden on the pushing rod assembly 3 when the cantilever 2 rises.

Furthermore, a first mounting hole is disposed on the second end of the assisting plate 6, a second mounting hole is disposed on the first fixing base 9, and hooks are respectively disposed at both ends of the assisting structure 4. One end of the assisting structure 4 hangs on the first mounting hole, and the other end is hung on the second mounting hole. With the above arrangements, the assisting structure 4 can be quickly installed and easily disassembled without complicated tools or steps, and is easy to replace and maintain.

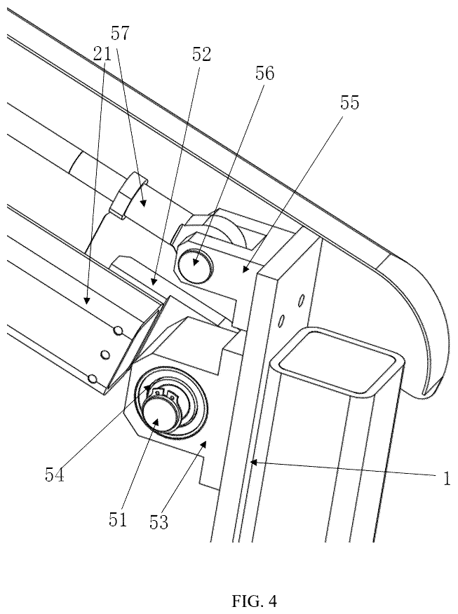

In some embodiments of the present application, as shown in FIGS. 3-4, the cantilever lifting mechanism may further include a limiting element 52 and a first rotating shaft 51, one end of the limiting element 52 is connected to a first end of the cantilever body 21, and the other end is rotatably connected to the column 1 through the first rotating shaft 51. Specifically, the column and the cantilever are rotatably connected at the first connection position through the first rotating shaft.

With the above arrangements, the limiting element 52 of the present application is in a rotational cooperation with the first rotating shaft 51, so that the cantilever 2 can rotate smoothly relative to the column 1.

Specifically, the limiting element 52 includes two limiting plates arranged opposite to each other, and an accommodation space is defined between the two limiting plates. The first end of the cantilever body 21 may extend into the accommodation space. The two limiting plates are respectively arranged on both sides of the cantilever body 21, so as to prevent the cantilever 2 from shaking left and right. The cantilever lifting mechanism of the wrapping machine of the present application may further include a first bearing base 53 and a first bearing 54. The first bearing base 53 is mounted on the column 1, and at least a part of the first bearing base extends into and is limited in the accommodation space. The first bearing 54 is mounted on the first bearing base 53, and the first rotating shaft passes through the first bearing. The first rotating shaft 51 may pass through the first bearing 54, the limiting element 52, and the power plate 6. The first bearing 54 is also limited in the accommodation space.

The cooperation between the first bearing base 53 and the first bearing 54 can make the cantilever 2 rotate more smoothly.

In some embodiments, the cantilever lifting mechanism may further include a cantilever sub-body 57, a C-shaped slot component 55 and a second rotating shaft 56. The cantilever sub-body 57 is arranged in parallel with the cantilever main body 21. The C-shaped slot component 55 is mounted on the column 1. The cantilever sub-body 57 extends into the slot of the C-shaped slot component 55 and is rotatably connected to the C-shaped slot component 55 through the second rotating shaft 56.

The C-shaped slot member 55 can prevent the cantilever 2 from shaking left and right.

The film roll storage box 10 is mounted on the cantilever main body 21 and the cantilever auxiliary body 57.

In some embodiments, the pushing rod assembly 3 may include a second bearing base 31, a ball screw 32, a screw nut 33 and a driving assembly 7. The second bearing base 31 is pivotally connected to the column 1 or the first fixing base 9. One end of the ball screw 32 is pivotally connected to the cantilever 2. The screw nut 33 is configured to rotate in the second bearing base 31, the ball screw 32 is threadedly connected with the screw nut 33, and the driving assembly 7 is configured to drive the screw nut 33 to rotate. When working, the driving assembly 7 drives the screw nut 33 to rotate, and the rotation of the screw nut 33 drives the ball screw 32 to move axially, thereby driving the first end of the cantilever 2 to rise and fall.

In some embodiments, the driving assembly 7 may include a motor 71, a first sprocket 72, a second sprocket 73 and a chain 74. The motor 71 is mounted on the second bearing base 31. The motor 71 is connected to the first sprocket 72 in a transmission manner, the second sprocket 73 is connected to the screw nut 33, and the first sprocket 72 is connected to the second sprocket 73 via the chain 74 in a transmission manner.

In some embodiments, the ball screw pushing rod may further include a nut base 34 and a second bearing 35. The nut base 34 is disposed between the second bearing base 31 and the screw nut 33, the second bearing base 31 and the nut base 34 are in a rotational cooperation via the second bearing, and the screw nut is mounted in the nut base 34.

In some embodiments, the driving assembly 7 may include a reducer 75, and a motor 71. The reducer 75, the first sprocket 72, the chain 74, the second sprocket 73, the screw nut 33, and the ball screw 32 are sequentially connected in transmission manners.

With above arrangements, after the screw nut 33 is driven to rotate, since the screw nut 33 is threadedly connected to the ball screw 32 and the screw nut 33 remains at its axial direction, the ball screw 32 moves along the axial direction of the screw nut 33, thereby driving the cantilever 2 to rise and fall.

In some embodiments, the second sprocket 73 may be mounted on the nut base 34.

In some embodiments, a bearing bracket 36 is disposed on the second bearing base 31, and the motor 71 and a second limiting switch 84 are both mounted on a bearing bracket 36.

In some embodiments, a side wall of the column 1 is provided with a second connecting base 37, and a side wall of the cantilever 2 is provided with the first connecting base 38. The second bearing base 31 is rotatably connected to the second connecting base 37, and one end of the ball screw 32 is rotatably connected to the first connecting base 38.

In the present application, the ball screw of the pushing rod assembly has low wear and a long service life when properly maintained, thereby reducing the frequency of maintenance and replacement. The ball screw is also easily integrated with control systems such as servo motors, enabling precise control of speed and position. Since there is no sliding involved, accurate transmission is ensured without the risk of slippage. Moreover, the structure is compact and space-saving. The use of the ball screw structure also improves transmission efficiency and reduces energy consumption, thereby providing significant economic value.

In some embodiments, a first limiting detection block 81 and a second limiting detection block 82 are respectively disposed at two ends of the ball screw, and a first limiting switch 83 and a second limiting switch 84 are disposed on the second bearing base 31. When the first limiting switch 83 detects the first limiting detection block 81 or when the second limiting switch 84 detects the second limiting detection block 82, the driving assembly 7 stops driving the screw nut to rotate.

With the above arrangements, the wrapping machine of the present application can limit the rotation angle of the cantilever 2 effectively.

As shown in FIG. 12,the wrapping machine may further include a vehicle body 8, and the cantilever lifting mechanism is installed on the vehicle body 8.

Furthermore, the first fixing base 9 is installed on the vehicle body 8.

The bottom of the column 1 is mounted on the vehicle body 8, or the bottom of the column 1 is mounted on the first fixing base 9.

In the present application, the assisting structure 4 and the ball screw structure are combined in one cantilever lifting mechanism of the wrapping machine, which improves the transmission efficiency, further reduces energy consumption, and increases the endurance time of the wrapping machine.

The above description is only a preferred embodiment of the present application, and does not limit the implementation mode and protection scope of the present application. For those skilled in the art, it should be understood that all solutions obtained by equivalent substitutions and obvious changes made using the description and illustrations of the present application should be included in the protection scope of the present application.

What is claimed is:

1. A wrapping machine, comprising a cantilever lifting mechanism, wherein the cantilever lifting mechanism comprises:
a cantilever, which comprises a first end and a second end;
a column, which is rotatably connected to the cantilever at a first connection position, the first connection position being closer to the second end of the cantilever;
a pushing rod assembly, which is connected to the cantilever at a second connection position, the pushing rod assembly being configured to drive the cantilever to rotate relative to the column;
an assisting structure, which is connected to the cantilever at a third connection position, and the assisting structure being configured to provide assisting force for the first end of the cantilever to rise.

2. The wrapping machine according to claim 1, wherein the second connection position and the third connection position are respectively located on two sides of the first connection position.

3. The wrapping machine according to claim 2, wherein the third connection position is located at the second end of the cantilever.

4. The wrapping machine according to claim 3, wherein one end of the assisting structure is connected to the cantilever at the third connection position, the other end is connected to a first fixing base, and the first fixing base is arranged in or near a bottom area of the column.

5. The wrapping machine according to claim 4, wherein the assisting structure is a tension spring or a spring balancer.

6. The wrapping machine according to claim 4, wherein the column comprises a first side and a second side, the first side of the column is closer to the second connection position and the second side of the column is further away from the second connection position, the first connection position is located on the first side of the column, and a distance between the third connection position and the second side of the column is smaller than a distance between the third connection position and the first side of the column.

7. The wrapping machine according to claim 1, wherein the second connection position and the third connection position are located on a same side of the first connection position.

8. The wrapping machine according to claim 7, wherein an upper end of the assisting structure is connected to the third connection position, and the assisting structure is a compression spring or a gas spring.

9. The wrapping machine according to claim 7, wherein the assisting structure is a spring balancer, the third connection position is located on an upper surface of the cantilever, and a movable end of the spring balancer is connected to the third connection position by passing through the second end of the cantilever.

10. The wrapping machine according to claim 5, wherein the cantilever comprises a cantilever body and an assisting plate, a first end of the assisting plate is connected to one end of the cantilever body, and a second end of the assisting plate extends along an axial direction of the cantilever body in a direction away from the cantilever body to form the second end of the cantilever.

11. The wrapping machine according to claim 10, wherein the cantilever lifting mechanism further comprises a limiting element and a first rotating shaft, one end of the limiting element is connected to a first end of the cantilever body, and the other end of the limiting element is rotatably connected to the column through the first rotating shaft, and the column and the cantilever are rotatably connected at the first connection position through the first rotating shaft.

12. The wrapping machine according to claim 11, wherein the limiting element comprises two limiting plates arranged opposite to each other, an accommodation space is defined between the two limiting plates, the first end of the cantilever body extends into the accommodation space, and the two limiting plates are respectively arranged on both sides of the cantilever body.

13. The wrapping machine according to claim 12, wherein the cantilever lifting mechanism further comprises a first bearing base and a first bearing, the first bearing base is mounted on the column, at least a part of the first bearing base extends into and is limited in the accommodation space, the first bearing is mounted on the first bearing base, and the first rotating shaft passes through the first bearing.

14. The wrapping machine according to claim 4, wherein the pushing rod assembly comprises a second bearing base, a ball screw, a screw nut and a driving assembly, the second bearing base is pivotally connected to the column or the first fixing base, one end of the ball screw is pivotally connected to the cantilever, the screw nut is configured to rotate in the second bearing base, the ball screw is threadedly connected to the screw nut, and the driving assembly is configured to drive the screw nut to rotate.

15. The wrapping machine according to claim 14, wherein the driving assembly comprises a motor, a first sprocket, a second sprocket and a chain, the motor is mounted on the second bearing base, the motor is connected to the first sprocket in a transmission manner, the second sprocket is connected on the screw nut, and the first sprocket is connected to the second sprocket via the chain in a transmission manner; the pushing rod assembly further comprises a nut base and a second bearing, the nut base is disposed between the second bearing base and the screw nut, the second bearing base and the nut base are in a rotation cooperation via the second bearing, and the screw nut is mounted in the nut base.

16. The wrapping machine according to claim 15, wherein a first limiting detection block and a second limiting detection block are respectively disposed at two ends of the b all screw, and a first limiting switch and a second limiting switch are disposed on the second bearing base, and when the first limiting switch detects the first limiting detection block or when the second limiting switch detects the second limiting detection block, the driving assembly stops driving the screw nut to rotate.
